(19) United States
(12) Patent Application Publication
(10) Pub. No.: US 2016/0159334 A1
(43) Pub. Date: Jun. 9, 2016

(54) Hand Brake Valve For Braking Systems Of Pneumatically Braked Motor Vehicles

(71) Applicant: WABCO GMBH, Hannover (DE)

(72) Inventor: Wolfgang Lichtenberg, Hannover (DE)

(21) Appl. No.: 14/904,589

(22) PCT Filed: Jun. 4, 2014
(86) PCT No.: PCT/EP2014/001515

§ 371 Date: Jan. 12, 2016

(30) Foreign Application Priority Data
Jul. 15, 2013 (DE) 10 2013 011 787.9

(51) Int. Cl. B60T 15/02; G05G 1/04; G05G 5/06; B60T 7/10; B60T 15/04

(52) U.S. Cl. CPC B60T 15/027; B60T 7/102; B60T 15/041; G05G 5/06; G05G 1/04

(57) ABSTRACT

A hand brake valve (1) for braking systems of pneumatically braked motor vehicles includes a rocking lever (2) pivotably guided in a lever housing (4) and connected to a control element (9, 10) for actuating the hand brake valve mechanism (7), the rocking lever bears a shift handle (3) and is configured to be pivoted into different operating positions guided in a shift gate (13), wherein the rocking lever comprises a locking element (12) that cooperates with the shift gate and that slides along a curved sliding path (15) of the shift gate, wherein a locking groove (16) is radially formed in the curved sliding path (15), the locking element being snapped into said locking groove in the locked position, and wherein the hand brake valve comprises an electrical switching element (22) configured to be actuated exclusively in the locked position.

### TECHNICAL FIELD

The invention relates to a hand brake valve for braking systems of pneumatically braked motor vehicles.

### BACKGROUND OF THE INVENTION

Hand brake valves are used for pneumatically braked motor vehicles, in particular utility motor vehicles, but also for towing vehicles used in agriculture in order to be able to place the motor vehicle, and optionally the trailer thereof, in a parked position secure from rolling. A control element, generally in the form of a cam disk, connected to a rocking lever, actuates the actual valve mechanism of the hand brake valve in a corresponding position of the rocking lever. The actuation of the valve mechanism ensures that the parking brake cylinders are ventilated, whereby the brakes of the vehicle or the trailer thereof are applied.

In the parked position, the rocking lever is generally blocked in a shift gate so that the rocking lever is not able to enter its released position automatically. In conventional hand brake valves, in order to release the hand brake the driver has to lift up a handle of the rocking lever, whereby a locking element slides radially upwardly out of its locking groove and is able to be moved into the released position. Different solutions which relate to the shift gate, the lever and the blocking of the rocking lever are disclosed, for example, in DE 27 12 945 C2 and EP 0 171 569 B1. It is also already known to provide an electrical switching element on or in the lever housing of the hand brake valve, said electrical switching element switching a lighting means connected to the instrument panel, in the locked position of the rocking lever, so that the driver obtains an optical signal when the hand brake valve is in its locked position. Such a hand brake valve is sold, for example by the applicant, with the part number 961 723 118 0 and has proved effective for many years. However, in rare exceptional cases the problem may occur that the rocking lever appears to be locked, which is indicated to the driver by the illumination of the lamp switched by the switching element. However, this safety measure may be misleading, namely when the rocking lever is in an intermediate position, i.e. when the rocking lever does not remain fully engaged but appears engaged to the driver. Such positions in such hand brake valves are known as so-called “tooth-on-tooth positions”. In this case, even with the slightest vibration, for example by closing the driver's door, it may result in the rocking lever slipping out of this dangerous intermediate position and into its released position. The brake is then released and the vehicle may start to roll which may result in serious accidents.

DE 33 46 018 A1 has already dealt with this problem. This publication describes a solution to the problem in which the electrical switching element only becomes effective, i.e. engaged, when the locking element has actually adopted its locked position. In the solution according to DE 33 46 018 A1, the switching element configured as a plunger-operated switch, roller switch or reed contact switch is directly connected to the control element configured as a cam disk. As a result, a hand brake lever which triggers the switching element only in the genuinely locked state is provided, whereby a lamp is illuminated only in the fully locked state and this signals to the driver that effective locking has taken place. Nevertheless, this solution also provides further room for improvement. It is considered a drawback with the solution described above that the switching element is arranged in the interior of the lever housing and is connected to the control element. As a result, the mounting of the switching element or replacement in the event of a malfunction is difficult and in addition the hand brake valves described in the introduction are becoming increasingly compact so that in the interior thereof there is barely any more space for additional components.

### SUMMARY

The present disclosure provides a hand brake valve of the type set forth above with a switching element which reliably indicates the locked state of the rocking lever and is connected to the hand brake valve such that simple mounting and a replacement of parts is possible.

A hand brake valve for braking systems of pneumatically braked motor vehicles of the type set forth above has an actuating member of the electrical switching element that is arranged at least partially in the locking groove and radially above the groove base and being able to be directly actuated by the locking element.

The actuating member is thus not concealed deeply in the interior of the lever housing and connected to the control element but fastened to the lever housing at least partially outside said lever housing. This permits simple and rapid mounting of the actuating member. Moreover, by the arrangement according to the invention a repair which might be required is also able to be carried out in a simple manner as the actuating member is much more easily accessible.

According to a further aspect of the invention, it is provided that the actuating member of the electrical switching element is a rocker pivotably mounted on the lever housing, the front end thereof being operatively connected to the locking element and the rear end thereof being operatively connected to the switching element.

In a further practical development of the invention, it is provided that the electrical switching element is a micro-switch which is arranged in or on the lever housing.

A further aspect of the invention is that the rocker is a stamped sheet metal part.

In another aspect of the invention, it is provided that the front end of the rocker is angled back, wherein the angled-back end protrudes into the locking groove and at least in the unactuated state is arranged at a short distance radially above the groove base.

According to a further aspect of the invention, it is provided that the rocker is mounted on an axial pin in the region of its pivot axis. In this case, the axial pin may be fastened directly to the outside of the lever housing, for example by a screw. However, it may also be arranged in a separate housing part of the actuating member.

A particular development of the invention is that a spring element acts against the front end or against the rear end of the rocker so that the rocker in the unactuated state is spaced apart from the groove base and from the electrical switching element.

According to a further aspect of the invention, the spring element is a leg spring, the spring eye thereof being mounted coaxially on the axial pin of the rocker.

Alternatively, it may be provided that the spring element is a helical compression spring which is mounted in a blind bore in the groove base of the locking groove.

A particularly expedient solution is provided in that at least the rocker is arranged in a rocker housing which is connected to the lever housing.

According to a further aspect of the invention, the rocker housing is connected to the lever housing by a locking connection.

Further aspects of the invention are explained in greater detail below by means of preferred illustrative embodiment with reference to the attached drawings. The drawings are provided for purely illustrative purposes and are not intended to limit the scope of the present invention.

### BRIEF DESCRIPTION OF THE DRAWINGS

Further details of the invention are described in more detail with reference to an exemplary embodiment in the drawings, in which:

FIG. 1 shows an exemplary embodiment of the hand brake valve according to the invention in longitudinal section and in a partial view,

FIG. 2 shows the hand brake valve of FIG. 1 with the locked pivot lever,

FIG. 3 shows a lever housing of the hand brake valve of FIG. 1 in a perspective view, and

FIG. 4 shows an actuating member of the hand brake valve for connecting to the lever housing of FIG. 3 in a perspective view.

### DETAILED DESCRIPTION OF THE DRAWINGS

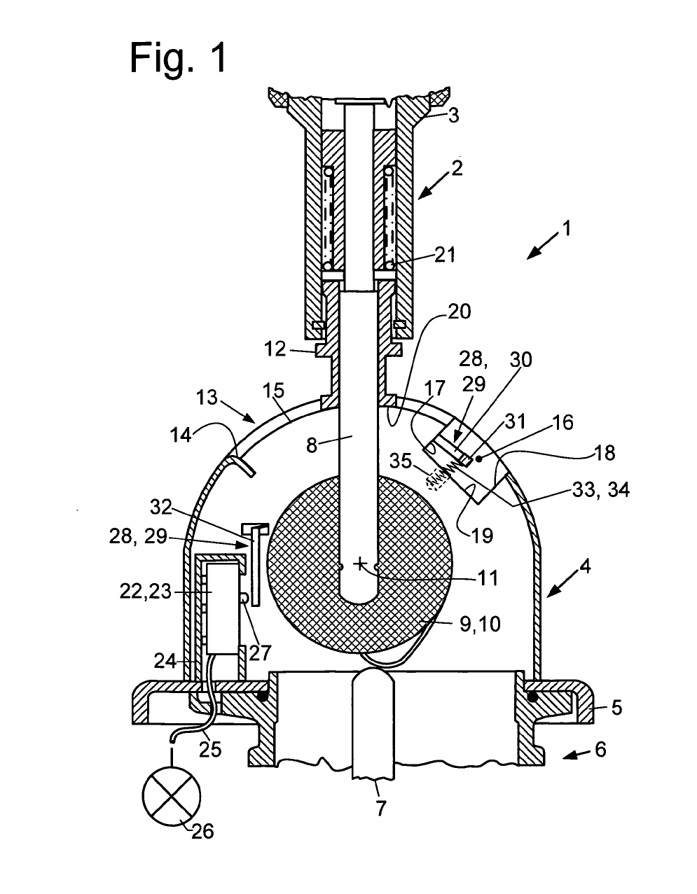

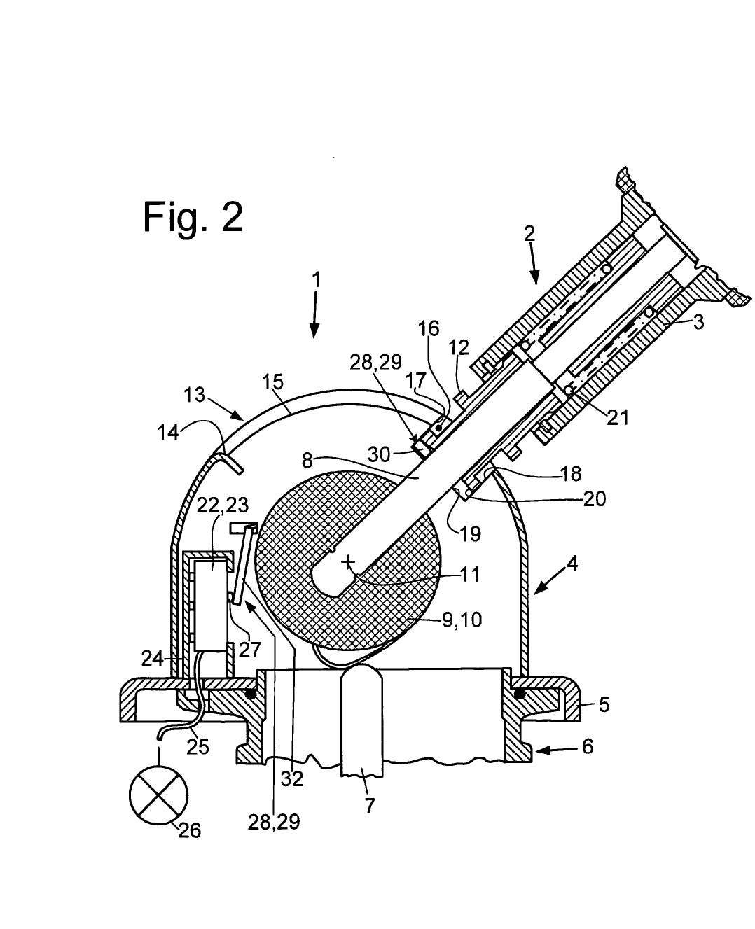

In FIG. 1 and FIG. 2 an exemplary embodiment is shown of a hand brake valve 1 according to the invention in longitudinal section and in a partial view. In pneumatically braked vehicles, the hand brake valve 1 serves to engage the parking brake when a parked position is reached and/or to release the parking brake again if it is desired to move the vehicle.

The hand brake valve 1 has substantially four sub-assemblies, namely a pivot lever 2 with a shift handle 3, only shown by way of indication, a lever housing 4 in which the pivot lever 2 is pivotably movably mounted, a fastening flange 5 for fastening the hand brake valve to an instrument panel of the vehicle, and a valve housing 6 only shown by way of indication.

The valve housing 6 contains pneumatic components of the hand brake valve 1. Indicated in FIG. 1 is simply a valve plunger 7 which, depending on the pivoted position of the pivot lever 2, is able to be actuated by a control element 9 in the form of a cam disk 10 rigidly connected to a shaft 8 of the pivot lever 2. The valve plunger 7 effectively represents the entire hand brake valve mechanism arranged in the valve housing 6.

The pivot lever 2, the pivot axis thereof being indicated by 11, has a locking element 12 which is configured as a sleeve and is arranged concentrically about the shaft 8 of the pivot lever 2 and is tensioned against a shift gate 13 arranged radially outwardly on the lever housing 4. The shift gate 13 has a stop 14, a curved sliding path 15 and a locking groove 16 which is radially inwardly formed in the curved sliding path 15 relative to the pivot axis 11. The locking groove 16 has groove walls 17, 18 and a groove base 19.

When the pivot lever 2 is pivoted, the locking element 12 slides with its lower face 20 along the sliding path 15 and namely from the stop 14 to the locking groove 16. The position on the stop 14 in this case represents the released position of the hand brake valve 1, in which the parking brake is released. If the locking element 12 slides beyond the sliding path 15 into the region of the locking groove 16 and/or over the locking groove 16, the locking element 12 is forced radially inwardly toward the pivot axis 11 into the locking groove 16 by a spring 21 mounted in the shift handle 3 and snaps into the locking groove 16. The pivot lever 2 is now locked. In this locked position which is shown in FIG. 2, the hand brake valve mechanism is triggered, i.e. the parking brakes of the utility vehicle and optionally the trailer thereof are permanently applied; the vehicle is no longer able to roll.

In order to indicate to the driver optically and/or optionally acoustically that the pivot lever has adopted its locked position shown in FIG. 2, and therefore the driver is able to leave the vehicle without danger, an electrical switching element 22 is provided in the form of a micro-switch 23 which is arranged in a chamber 24 of the lever housing 4. Electrical leads 25 of the electrical switching element 22 are connected to a switching circuit of a display means in the form of a lamp 26, only shown by way of indication, which may be connected to the instrument panel of the vehicle or the lever housing 4. The switching element 22 has a button 27. If this button is subjected to pressure the switching element is switched and the lamp 26 is illuminated.

In known solutions of the prior art, the actuating member required for actuating the button 27 was connected to the cam disk 10. According to the invention, the actuating member 28 of the electrical switching element 22 is arranged at least partially in the locking groove 16 and radially above the groove base 19 and is able to be actuated directly by the locking element 12.

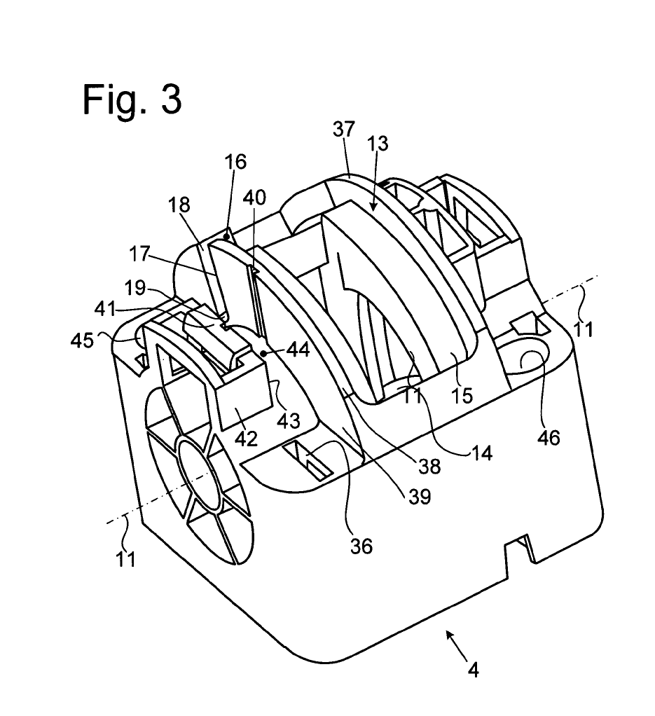

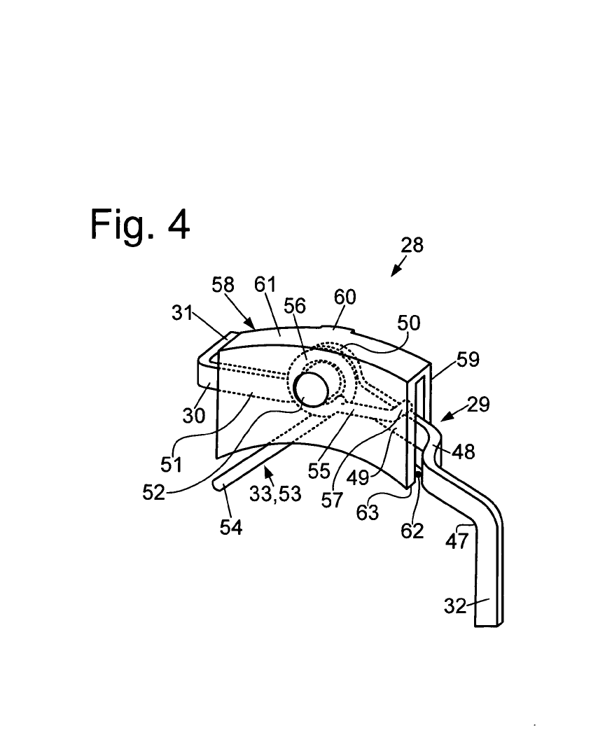

The actuating member 28 is configured as a rocker 29 and is described in more detail with reference to FIGS. 3 and 4. In FIGS. 1 and 2 it may be identified that the rocker 29 has a front end 30 which is angled back axially inwardly into the lever housing 4, wherein the angled-back end 31 protrudes into the locking groove 16 and at least in the unactuated state is arranged radially at a distance above the groove base 19. The front end 30 of the rocker 29 is thus operatively connected to the locking element 12 as shown in FIG. 2.

A rear end 32 of the rocker 29, however, is operatively connected to the electrical switching element 22. In the unactuated state shown in FIG. 1, the rear end 32 of the rocker 29 is spaced apart from the button 27 of the electrical switching element 22.

If the pivot lever 2 pivots into the locked position of FIG. 2 so that the locking element 12 snaps into the locking groove 16, the lower face 20 of the locking element 16 forces the front end 30 of the rocker 29 down. Corresponding to the downward movement of the front end 30 of the rocker 29, the rear end 32 of the rocker 29 performs an upward movement and presses against the button 27 of the electrical switching element 22 which results in the illumination of the lamp 26.

In this manner, it is ensured that the lamp 27 is only illuminated when the locking element 12 is fully snapped into the locking groove 16 and thus a secure locking of the pivot lever 2 free of vibrations is ensured.

In order to ensure in the unlocked state the required spacing of the front end 30 of the rocker 29 to the groove base 19, and in order to reliably avoid an undesired actuation of the button 27 of the electrical switching element 22 by the rear end 32 of the rocker 29, a spring element 33 is provided, said spring element acting against the front end 30 of the rocker 29 so that the rocker 29 in the unactuated state remains spaced apart from the groove base 19. In the exemplary embodiment according to FIGS. 1 and 2, the spring element 33 is configured as a helical compression spring 34 which is mounted in a blind bore 35 in the groove base 19.

In FIG. 3 the lever housing 4 of the hand brake valve 1 is shown in a perspective view. The lever housing 4 corresponds substantially to the lever housing of FIGS. 1 and 2 and also has a shift gate 13 with a stop 14, a curved sliding path 15 and a locking groove 16 which is radially inwardly formed in the curved sliding path 15 relative to the pivot axis 11. The locking groove 16 also has groove walls 17, 18 and a groove base 19, wherein the spacing of the groove walls 17, 18 from one another is less than in the view according to FIGS. 1 and 2. Accordingly, the lower face 20 of the locking element 12, not shown in FIG. 3, has a smaller surface so that it is accordingly able to snap into the narrower locking groove 16.

In FIG. 3 the actuating member 28 and the electrical switching element 22 are not shown, nor are the pivot lever 2, the flange 5 and the valve housing 6.

The actuating member will be described in connection with FIG. 4. FIG. 3 shows a housing opening 36, through which the rear end 32 of the rocker 29 of the actuating member 28 is able to be inserted into the lever housing 4. FIG. 4 shows edges 37, 38 which axially define the sliding path 15 and which protrude radially over the sliding path 15. A substantially radially extending dovetail groove 40 is incorporated in an outer wall 39 of the left-hand edge 38 in FIG. 3. The dovetail groove 40 serves for fastening the actuating member 28 according to FIG. 4.

Arranged axially opposite the dovetail groove 40 is a snap hook 41 which also serves for fastening the actuating member 28 according to FIG. 4. The snap hook 41 is integrally fastened to a housing pillar 42, wherein an axial inner wall 43 of the housing pillar 42 is arranged parallel and axially spaced apart from the outer wall 39 of the left-hand edge 38 in FIG. 3, so that an open insertion pocket 44 for the actuating member 28 is formed in the peripheral direction of the lever housing 4.

Threaded bolts 45, 46, not shown, serve for fastening the lever housing 4 to the fastening flange 5 and to the valve housing 6 being guided through said bores. The lever housing 4 is configured as a one-piece plastics part but may also consist of a different material and may be configured in multiple parts.

In FIG. 4 the actuating member 28 which may be connected to the lever housing according to FIG. 3 is shown in a perspective view.

The actuating member 28 configured as a rocker 29 has—as already explained in connection with FIGS. 1 and 2 the front end 30 which is angled back axially inwardly in the direction of the locking groove 16 of the lever housing 4, wherein the angled-back end 31 in the mounted state of the actuating member 28 protrudes into the locking groove 16 and at least in the unactuated state is arranged at a distance radially above the groove base 19. The front end 30 of the rocker 29 is thus operatively connected to the locking element 12.

Conversely, the rear end 32 of the rocker 29 is operatively connected to the electrical switching element 22. In the unactuated state shown in FIG. 1, the rear end 32 of the rocker 29 is spaced apart from the button 27 of the electrical switching element 22. The rear end 32 is oriented radially inwardly toward the interior of the lever housing 4. Proceeding from the rear end 32 the rocker 29 configured as a stamped sheet metal part has a bent-back portion 47, which is bent-back approximately at a right angle, and an S-shaped curve 48 extending substantially axially which merges with a linear region or leg 49 which extends as far as a pivot point with an eye 50. Thus a leg 51 forming the front end 30 is integrally formed on the eye 50.

An axial pin 52 is guided through the eye 50 of the rocker 29; the rocker 29 may rotate about the axial pin 52. Apart from the rocker 29 the spring element 33 is mounted on the axial pin 52, wherein the spring element 33 in contrast with the exemplary embodiment according to FIG. 1 is not configured as a helical compression spring but as a torsion spring in the form of a single-winding leg spring 53. The leg spring 53 has two spring arms 54, 55 and a spring eye 56 which connects both spring arms 54, 55, which is mounted on the axial pin 52 and which is arranged in the axial direction in front of the rocker 29. Whilst the free spring arm 54 is tensioned against the lever housing 4, the spring arm 55 as a rocker spring 55 is tensioned against the leg 49 of the rear end 32 of the rocker, by an angled-back end 57 of the spring arm 55 bearing against the leg 49. By this arrangement the rear end 32 of the rocker 29 is forced downwardly and at the same time the front end 30 of the rocker 29 is forced upwardly.

The rocker 29, the leg spring 53 and the axial pin 52 are arranged in a rocker housing 58. A dovetail strip 60 extending substantially radially is integrally formed on a rear wall 59 of the rocker housing 58. For fastening the rocker housing 58 to the lever housing 4 according to FIG. 3, the dovetail strip 60 is inserted from the top into the dovetail groove 40 of the lever housing 4. After the rocker housing 58 has been fully inserted into the insertion pocket 44 of the lever housing 4, the snap hook 41 integrally formed on the housing pillar 42 of the lever housing 4 snaps over the upper face 61 of the rocker housing 58 so that the rocker housing 58 is then secured to the lever housing. When fastening the rocker housing 58 to the lever housing 4, the angled-back end 31 of the front end 30 of the rocker 29 is inserted into the locking groove 16, wherein at the same time the rear end 32 of the rocker 29 is inserted through the housing opening 36 of the lever housing 4 into said lever housing, so that the rear end 32 of the rocker 29 adopts its resting position in front of the button 27 of the electrical switching element 22.

For mounting the rocker 29 and the leg spring 53 in the rocker housing 58 a slot 62 which is incorporated longitudinally in the lower face 63 of the rocker housing 58 is provided. The rocker 29 and the leg spring 53 are inserted through the slot 62 into the rocker housing 58, after which the axial pin 52 is inserted from the rear through the rear wall 59 of the rocker housing 58, through the eye 50 of the rocker 29 and through the spring eye 56 of the leg spring 53.

While the above description constitutes the preferred embodiments of the present invention, it will be appreciated that the invention is susceptible to modification, variation and change without departing from the proper scope and fair meaning of the accompanying claims.

What is claimed is:

1. A hand brake valve (1) for braking systems of pneumatically braked motor vehicles, comprising:
a rocking lever (2) pivotably guided in a lever housing (4) and connected to a control element (9, 10) for actuating a hand brake valve mechanism (7), the rocking lever bears a shift handle and is configured to be pivoted into different operating positions by being guided in a shift gate (13), wherein the rocking lever (2) comprises a locking element (12) that cooperates with the shift gate (13) and that slides along a curved sliding path (15) of the shift gate (13), wherein a locking groove (16) with groove walls (17, 18) and a groove base (19) is radially formed in the curved sliding path (15), the locking element (12) being snapped into said locking groove in a locked position, and wherein the hand brake valve (1) comprises an electrical switching element (22) configured to be actuated exclusively in the locked position of the locking element (12) in the locking groove (16), and wherein an actuating member (28) of the electrical switching element (22) is arranged at least partially in the locking groove (16) and radially above the groove base (19) and is configured to be directly actuated by the locking element (12).

2. The hand brake valve as claimed in claim 1, wherein the actuating member (28) of the electrical switching element (22) is a rocker (29) pivotably mounted on the lever housing (4), a front end (30, 31) of the rocker being operatively connected to the locking element (12) and a rear end (32) of the rocker being operatively connected to the switching element (22).

3. The hand brake valve as claimed in claim 1, wherein the electrical switching element (22) is a micro-switch (23) which is arranged in or on the lever housing (4).

4. The hand brake valve as claimed in claim 2, wherein the rocker (29) is a stamped sheet metal part.

5. The hand brake valve as claimed in claim 2, wherein the front end (30) of the rocker (29) is angled back and protrudes into the locking groove (16) and, at least in an unactuated state, is arranged at a short distance radially above the groove base (19).

6. The hand brake valve as claimed in claim 2, wherein the rocker (29) has a pivot axis (50) and is mounted on an axial pin (52) near the pivot axis (50).

7. The hand brake valve as claimed in claim 6, wherein a spring element (33; 34; 53) acts against the front end (30; 31) or against the rear end (32; 48; 49) of the rocker (29) so that the rocker (29) in an unactuated state is spaced apart from the groove base (19) and from the electrical switching element (22).

8. The hand brake valve as claimed in claim 7, wherein the spring element (33) is a leg spring (53), and a spring eye (56) thereof is mounted coaxially on the axial pin (52) of the rocker (29).

9. The hand brake valve as claimed in claim 7, wherein the spring element (33) is a helical compression spring (34) mounted in a blind bore (35) in the groove base (19) of the locking groove (16).

10. The hand brake valve as claimed in claim 2, wherein the rocker (29) is arranged in a rocker housing (58) connected to the lever housing (4).

11. The hand brake valve as claimed in claim 10, wherein the rocker housing (58) is connected to the lever housing (4) by a locking connection (40, 60, 41).
